(19) United States
(12) Patent Application Publication
(10) Pub. No.: US 2023/0048821 A1
(43) Pub. Date: Feb. 16, 2023

(54) MACHINE FOR PRODUCING MARBLE TILES AND RELATED METHOD

(71) Applicant: SFERA SRL, MASSA (MS) (IT)

(72) Inventor: Stefano TONGIANI, MASSA (MS) (IT)

(73) Assignee: SFERA SRL, MASSA (MS) (IT)

(21) Appl. No.: 17/794,033

(22) PCT Filed: Jan. 22, 2021
(86) PCT No.: PCT/IT2021/050021

§ 371 Date: Jul. 20, 2022

(30) Foreign Application Priority Data
Jan. 23, 2020 (IT) 102020000001321

(51) Int. Cl. B28D 1/04

(52) U.S. Cl. CPC B28D 1/047; B28D 1/046

(57) ABSTRACT

A machine for producing tiles from a block, in particular a block of marble, granite and the like, includes a support surface for supporting the block; a plurality of first cutters for cutting the block parallel to a first horizontal direction, the first cutters being placed above the support surface, including respective lower edges, configured to cut the block on the upper part, the lower edges being placed at the same adjustable height, with reference to a vertical direction, and being arranged aligned along at least a first horizontal axis, parallel to a second horizontal line, orthogonal to the first horizontal direction; a second cutter for cutting the block parallel to the second horizontal line, the second cutter being configured to move along a second horizontal axis relative to the support surface, the second horizontal axis being parallel or inclined with respect to the second horizontal line by a first angle α<90°, the second cutter having, during use, a resting position, wherein it does not interact with the block, and a working position, including a lower edge placed at the same adjustable height as the first cutters; a horizontal blade for cutting the block along a horizontal plane, including a first cutting side placed at the same adjustable height as the first cutters, and the support surface is configured to move on the horizontal line along a first cutting direction, relative to the first cutters, to the second cutter, and to the horizontal blade, the horizontal blade being placed downstream of the first horizontal axis and the second horizontal axis, with reference to the first cutting direction. A method for cutting a block of marble and the like, into a plurality of tiles is also disclosed.

This invention relates to a machine for producing tiles made of marble, granite and the like, and the related method of operating such a machine.

More specifically, this invention relates to a machine for making tiles made of marble, granite and the like, from an initial monoblock.

As is well known, today, processing blocks of marble and the like for the production of tiles is carried out by means of a plurality of machines, each machine being dedicated to a specific function.

In particular, the block to be processed can be processed by the following known machines:
a first machine, in particular a block-cutting machine, configured to divide the block in a first thickness into a plurality of slabs, or “strips”, having a thickness greater than or equal to twice the thickness of the final tiles to be obtained, a width equal to the width of the final tiles to be obtained and a length substantially equal to that of the original block;
a second machine, in particular a continuous splitting machine, also called a cutting machine, configured to obtain, from each slab obtained by the first machine, two thin slabs having the thickness of the final tiles to be obtained; and
a third machine, in particular a multi-disc circular saw, capable of reducing the thin slabs obtained by the second machine into a plurality of finished tiles.

Further machines are required to carry out final processing operations to further characterise the surface of the tiles, such as: polishing machines, singeing machines, bush hammers, etc.

Specifically, the first known machine comprises one or more vertical discs capable of cutting the block into vertical slabs having constant thickness, and a horizontal or final detachment disc, movable along a horizontal direction, capable of dividing one-by-one the slabs having constant thickness so that they have a length substantially equal to that of the initial block.

In addition, the vertical disc is usually about 1 m in diameter, i.e. larger than the horizontal disc. As already mentioned, such first machine reduces the starting block into slabs which are unloaded by means of a robotic arm, which places them on a surface and turns them by 90°. The slabs obtained usually have a maximum height of 40 cm — 50 cm (dimension limited by the maximum size of the disc, which must be about 1200 mm in diameter to have 40 cm of slab) and a thickness of between 3 cm — 5 cm.

It is not possible to obtain slabs of a lesser thickness using said first machine as separating the slabs using the robotic arm would be particularly difficult and would significantly increase the likelihood of the slabs breaking.

Furthermore, the large size of the first vertical disc requires it to be thick enough to ensure stability, but it would produce an economically unacceptable loss of material (also known as debris material) if it were used to cut slabs less than 3 cm thick.

Each slab resting on a horizontal surface is processed by the second machine in such a way as to minimise the probability of breakage of the thin slabs obtained.

The second machine usually has a plurality of horizontal diamond discs configured to cut along a horizontal plane to divide each slab obtained by said first block-cutting machine into two thin slabs.

The second machine is connected to the third machine by means of a conveyor belt configured to transport the thin slabs obtained by said second machine to said third machine so as to minimise the probability of the breaking of the thin slabs.

The third machine comprises a plurality of vertical gcutting discs having their axis of rotation along a first horizontal line perpendicular to the length of the incoming slabs, capable of splitting said incoming thin slabs into a predefined number of tiles.

Alternatively, according to the background art, a plurality of tiles made of marble and the like can be obtained by the following machines placed in series:
a first multi-blade machine or gang-saw comprising a plurality of flat diamond blades tensioned longitudinally by means of tie-rods placed at their ends, which cut along a horizontal direction and which are spaced apart from each other at a first distance equal to the thickness of the tiles to be obtained, such blades sliding on vertical rectilinear guides;
a longitudinal sawing machine configured to act on the slabs produced by the first multi-blade machine, said longitudinal sawing machine comprising a plurality of vertical blades having their axis of rotation along a first horizontal direction, said blades being placed at a second distance from each other, said second distance being equal to the width of the tiles to be obtained; and
a multi-disc circular saw with vertical blades, configured to divide the thin slabs exiting the longitudinal sawing machine into a plurality of tiles ready for various final surface treatments, the blades of said multi-disc sawing machine having their axis of rotation in a second horizontal direction, orthogonal to the length of the thin slabs to be cut.

It is not necessary to use the splitting machine when tiles are obtained by the latter method, as the slabs obtained by the first multi-blade machine can have a minimum thickness of 1 cm. The slabs would be too fragile to be moved later below such thickness.

In such second sequence, the unloading of the slabs from the frame is always manual because the slabs are too large and delicate to be unloaded by a robotic arm. Furthermore, as all the slabs are already separated and held together by means of wooden wedges or shims, unloading them is a complex operation that cannot be easily automated.

The aim of this invention is to overcome the limitations of the background art.

In particular, the aim of this invention is to provide a single machine capable of obtaining a plurality of tiles from a block of marble.

Furthermore, the aim of this invention is for said machine to optimise the production of tiles, in terms of yield per unit of time, the quality of the final tiles and the debris produced.

A further aim of this invention is for such tiles to have smaller thicknesses than the background art.

Furthermore, the aim of this invention is to be able to automatically carry out surface processing which would otherwise not be possible after the final cut of the tile according to the background art as this would result in almost certain breakage, such as for example, shaping the surface or edge with a grinding wheel, or bush hammering, or all those processing operations which stress the material with vibrations and forces.

Furthermore, the aim of this invention is to have a machine capable of obtaining tiles having small dimensions, in particular mosaic tiles, smaller than 2 cm × 2 cm.

Finally, the aim of this invention is to provide a method for cutting such tiles. It is therefore a specific object of this invention to provide a machine for producing tiles from a block, in particular a block of marble, granite and the like, said machine comprising a support surface for supporting said block. In addition, said machine comprises a plurality of first cutting means for cutting said block parallel to a first horizontal line, wherein said first cutting means are arranged above said support surface. Further, said first cutting means comprise respective bottom edges, configured to carv said block on the upper part, said lower edges being arranged at the same adjustable height, with reference to a vertical line, and being arranged aligned along at least a first horizontal axis, parallel to a second horizontal line, orthogonal to said first horizontal line.

By way of example, said machine may comprise a first movable element, movable along said vertical line, said first movable element being arranged above said support surface and being adapted to create an insertion space with said support surface, for the insertion of said block. In such a case, said first cutting elements may be integral with said first movable element, being for example, installed on it.

Further, said machine comprises a second cutting means for cutting said block parallel to said second horizontal line, wherein said second cutting means is configured to move along a second horizontal axis relative to said support surface. In particular, said second horizontal axis is parallel to or inclined by a first angle α<90° with respect to said second horizontal line, and for example, may be arranged downstream or upstream of said at least a first horizontal axis with reference to a direction of said first horizontal line. Moreover, during use, said second cutting means has a resting position, wherein it does not interact with the block, and a working position, wherein it comprises a lower edge arranged at said same adjustable height as said first cutting means.

Further, said machine comprises a horizontal blade for cutting said block along a horizontal plane, wherein said horizontal blade comprises a first cutting side arranged at said same adjustable height as said first cutting means. For example, said horizontal blade may be coupled to said at least a first movable element.

Said support surface is configured to move in said first horizontal line along a first cutting direction, relative to said first cutting means, to said second cutting means, and to said horizontal blade, wherein said horizontal blade is arranged downstream of said first horizontal axis and said second horizontal axis with reference to said first cutting direction. Thus, during use, said block, resting on said support surface, may move with respect to said cutting means and said horizontal saw along said first cutting direction so that said first cutting means cut said block parallel to said first horizontal line at a predetermined width and at a predetermined depth. Further, said second cutting means may move from said resting position to said working position after said first cutting means has travelled a predetermined length along said first horizontal line so as to cut said block parallel to said second horizontal line at said predetermined length and at said predetermined depth. Finally, said horizontal blade can cut said block after the passage of said first discs, and possibly of said second disc, so as to form a plurality of uniform tiles starting from said block.

Finally, said second horizontal axis is inclined with respect to said second horizontal line by a first angle α<90°, and the relative motion between said support surface and said first cutting means has a speed along said first horizontal line, having a first intensity Vb.

When in working position, said second cutting means is therefore configured to move only along a second cutting direction of said second horizontal axis at a speed having a second intensity Ve equal to said first intensity Vb divided by the sine of said first angle α in such a way that during use, the relative speed between said support surface and said second cutting means in working position is zero with respect to said first horizontal line.

Preferably, according to the invention, said first cutting means may be a plurality of first rotating cutting discs having an axis of rotation along said at least a first horizontal axis.

Further, according to the invention, said second cutting means may be a second rotating cutting disc having an axis of rotation orthogonal to said second horizontal axis.

Further, according to the invention, said horizontal blade may be a band saw.

Also according to the invention, the machine may comprise spacer elements configured to be inserted into and pass through the cuts made on said block by said first cutting means so as to hold the formed tiles in place.

Further, according to the invention, said machine may comprise pre-treatment means which are adjustable along said vertical line and movable along said first horizontal line relative to said support surface, for example being connected to said at least a first movable element, for the pre-treatment of said block. In particular, said pre-treatment means may be arranged upstream of said first discs with reference to said first cutting direction and may be movable or fixed with respect to said second horizontal line. Specifically, said pre-treatment means may be an oxy-hydrogen flame and/or a polishing head.

Again, according to the invention, said machine may comprise a paddle configured to be adjustable along said vertical line and movable along said first horizontal line relative to said support surface, for example being connected to said at least a first movable element, said paddle able to have a resting position, wherein said paddle does not interact with said block, and a working position, wherein said paddle is in contact with a top surface of said block or of said support surface. Thus, said paddle may switch from said resting position to said working position after the formation of said plurality of tiles and their relative unloading, and said support surface may move with respect to said at least a first movable element in said first horizontal line, along a return direction, opposite to said first cutting direction, so that said pallet can drop the remaining debris outside said block.

In addition, said machine may comprise a trolley for collecting the debris, arranged below said support surface.

Also according to the invention, said first cutting means may be arranged in a staggered manner on two first horizontal axes which are parallel to each other.

Furthermore, according to the invention, the arrangement of said first cutting means on said at least a first horizontal axis may be adjustable. In particular, said machine may comprise a logic control unit for controlling, during use, the arrangement of said first cutting means on said at least a first horizontal axis.

Finally, according to the invention, said machine may be configured in such a way that, in use, said first intensity Vb of the speed of relative motion between said support surface and said first cutting means varies from a first value Vb1 to a second value Vb2 which is greater than Vb1, said first value Vb1 preferably being equal to about 10% of Vb2.

A further specific object of this invention is a method for cutting a plurality of tiles from a block, in particular a block of marble, granite and the like, said method being characterised in that it comprises the following steps:

A. moving said block along a first cutting direction in a first horizontal line; and simultaneously
B1. carving a top surface of said block with a plurality of carvings parallel to said first horizontal line, said plurality of carvings being spaced apart from one another by a first distance and having a predetermined depth, with reference to a vertical line;
B2. if said block has travelled a predetermined length with respect to said first cutting direction, cutting said top surface of said block at said predetermined length and at said predetermined depth, parallel to a second horizontal line, orthogonal to the first horizontal line, for the entire width of said block, optionally blocking the movement of said block in said first cutting direction;
B3. cutting the portion of said block, carved in said step B1 and/or in said step B2, on a plane horizontal to said predetermined depth; and
C. implementing said steps B1-B3 until said entire top surface of said block has been cut, obtaining a plurality of tiles having a length equal to a predetermined length, a width equal to said at least a first distance, and a thickness equal to said predetermined depth;
D. unloading said plurality of formed tiles and repeating said steps A-C, preferably until said block is exhausted;

wherein during said steps A, B1, B2 and B3, said block is moved with a first speed having a first intensity Vb with respect to said first cutting direction and the movement of said block in said first cutting direction is not blocked during said step B2. Furthermore, during said step B2, said carvings parallel to said second horizontal line are made by means of a second cutting means which is movable along a second horizontal axis in a second cutting direction, said second horizontal axis being inclined by a first angle a<90° with respect to said second horizontal line. In particular, said second cutting means moves along said inclined direction at a speed of movement having a second intensity Ve equal to said first intensity Vb divided by the sine of said first angle α, so as to make zero the relative speed of movement between said second cutting means and said block along said first horizontal line.

According to the invention, during said step B1 and/or said step B2, a sub-step may be provided of passage of spacer elements in the carvings parallel to said first horizontal line in order to stabilise the position of the tiles formed on said block.

Furthermore, the method according to the invention may comprise the following step:

E. pre-treating the surface of said block intended to be carved in said step B1 by means of pre-treatment means, preferably by means of an oxy-hydrogen flame and/or a polishing head.

Further, the method according to the invention may comprise the following step:
F. removing any debris from said block.

Furthermore, according to the invention, said first intensity Vb of the speed of movement of said block may vary from a first value Vb1 to a second value Vb2 which is greater than Vb1, said first value Vb1 preferably being equal to about 10% of Vb2.

Finally, the method according to the invention may be implemented by means of a machine according to this invention.

The invention will now be described by way of non-limiting example, with particular reference to the attached figures, wherein:

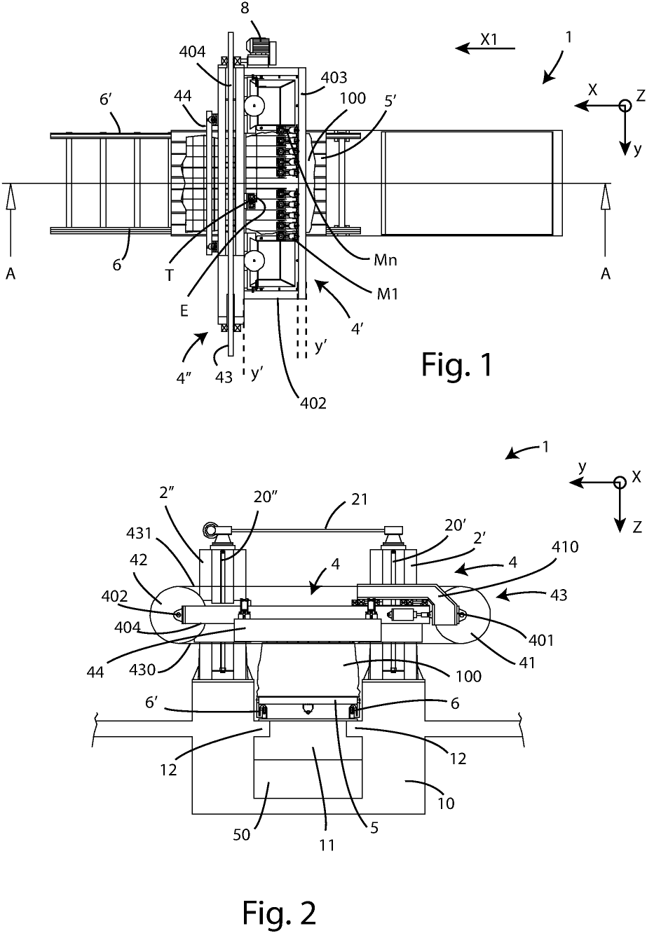

FIG. 1 shows a top view of a first machine, which is not an object of this invention, during a processing step of a marble block;

FIG. 2 shows a front view of the machine in FIG. 1, showing a debris ejection system, during a processing step of a marble block;

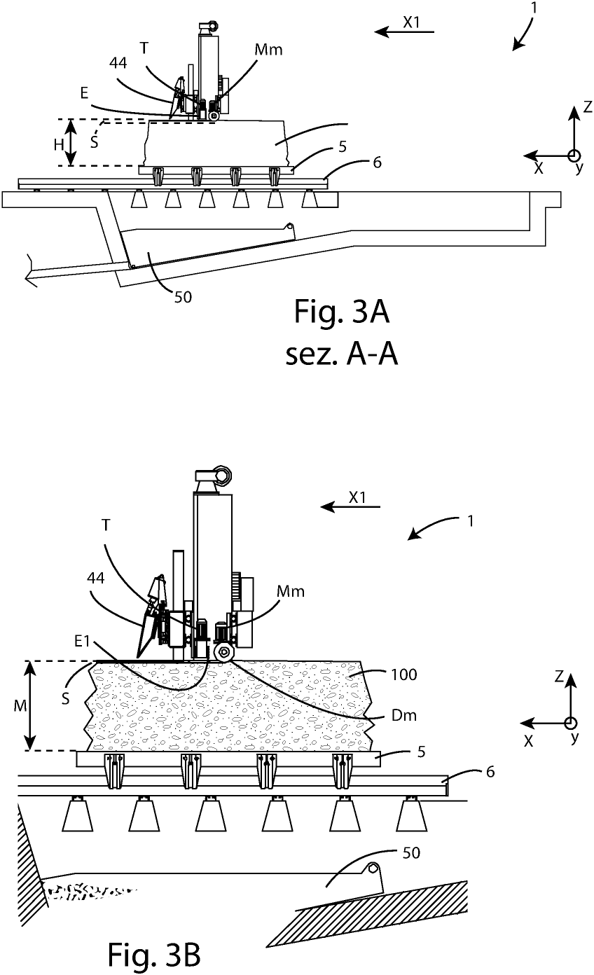

FIG. 3A shows a side view of section AA of the machine in FIG. 1, in a first processing step of a marble block;

FIG. 3B shows an enlargement of FIG. 3A, in a first processing step of a marble block;

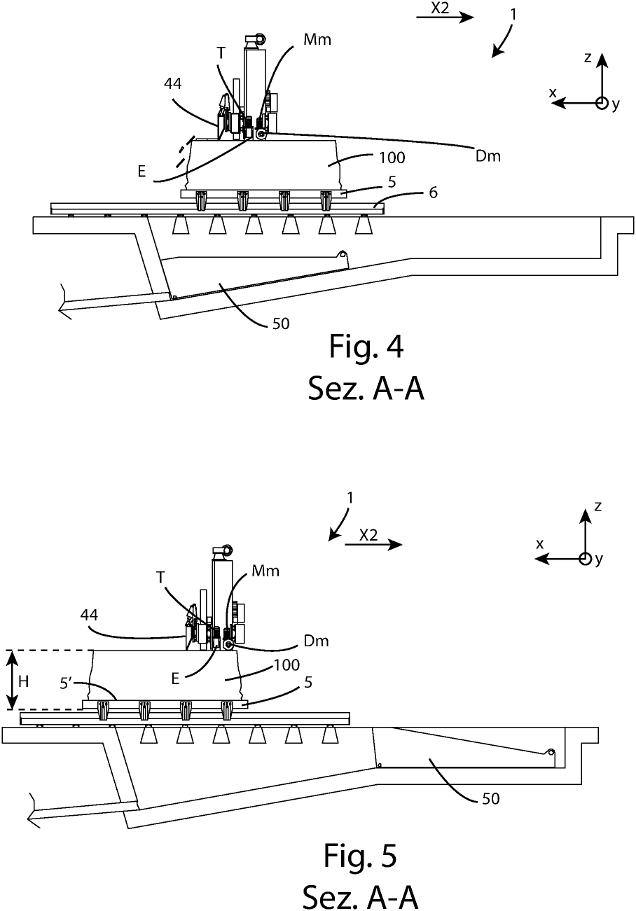

FIG. 4 shows a side view of section AA of the machine in FIG. 1, in a further processing step of a marble block, subsequent to the step shown in FIG. 3A;

FIG. 5 shows a side view of section AA of the machine in FIG. 1, in a further processing step of a marble block, subsequent to the step shown in FIG. 4;

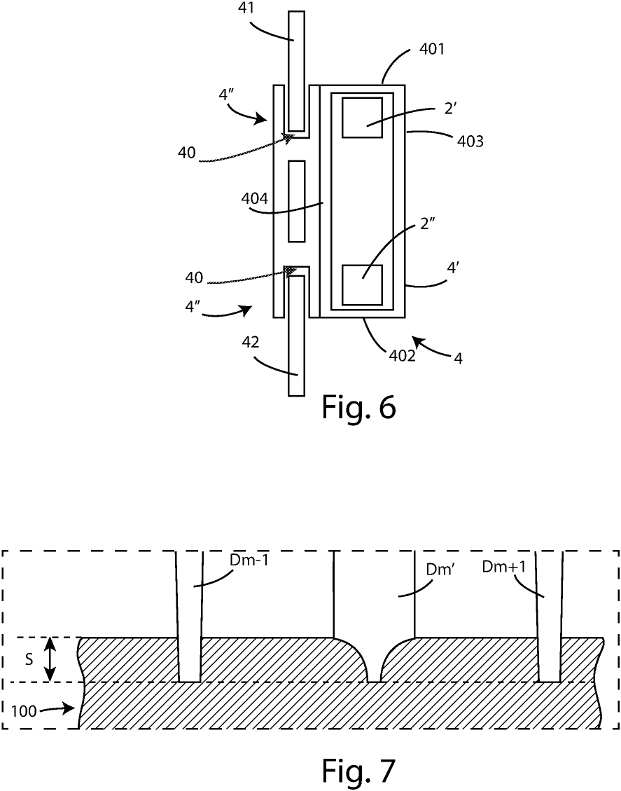

FIG. 6 shows a sectional top view of a detail of the machine in FIG. 1, and specifically the frame coupled to the columns of the machine in FIG. 1;

FIG. 7 shows a sectional side view of a block during a processing step using a machine according to this description;

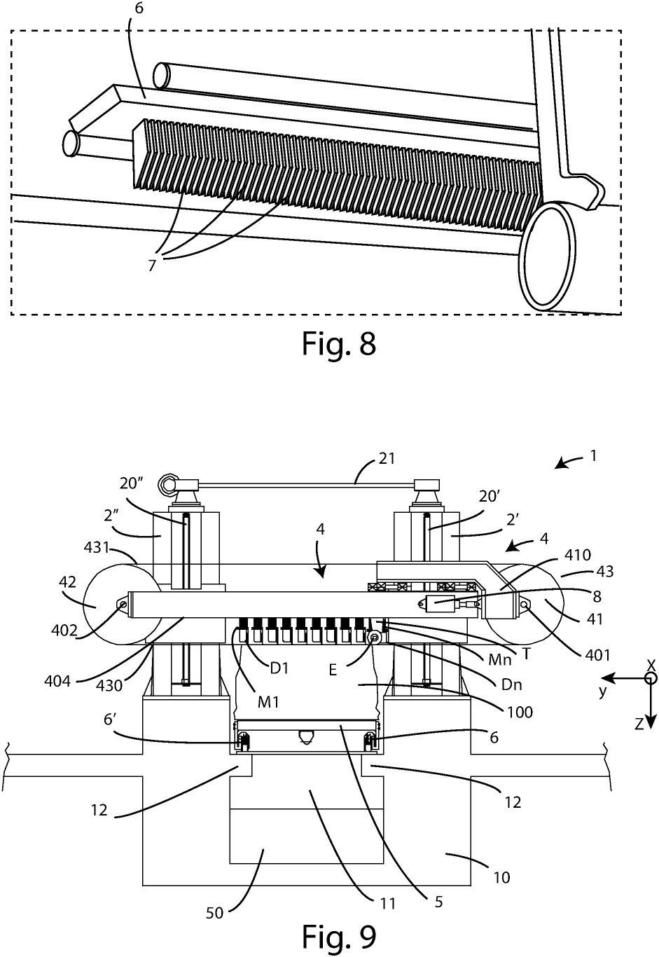

FIG. 8 shows a perspective view of a detail of a machine according to this description, comprising spacer elements to be passed, during use, between the cut tiles; FIG. 9 shows a partial sectional front view of a variant of the machine in FIG. 1, without the debris ejection system;

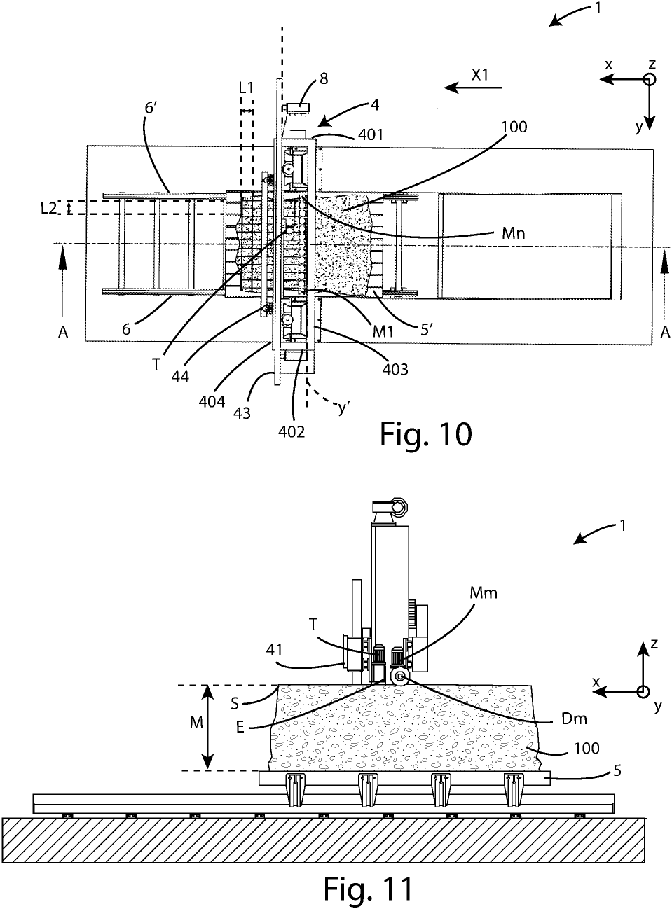

FIG. 10 shows a top view of a further variant of the machine in FIG. 1;

FIG. 11 shows a side view of section AA of the machine in FIG. 10, in a first processing step of a marble block;

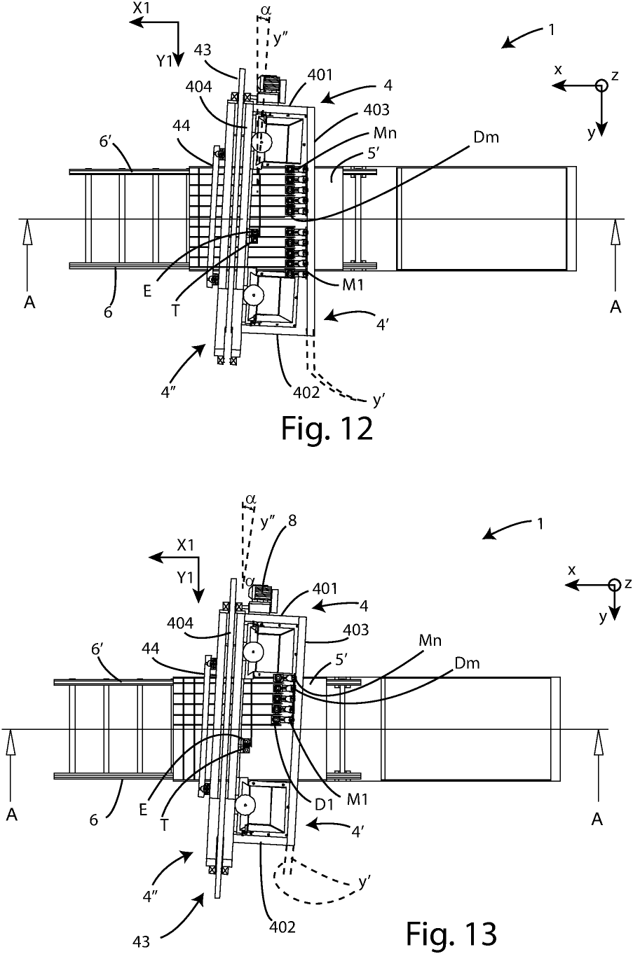

FIG. 12 shows a top view of a machine according to this invention, during a processing step of a marble block;

FIG. 13 shows a top view of a further embodiment of a machine according to this invention, during a processing step of a block of marble; and

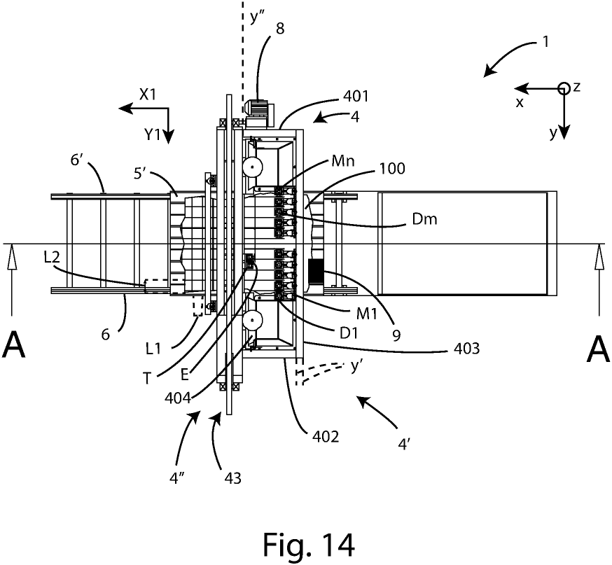

FIG. 14 shows a top view of a further machine which is not an object of this invention.

With particular reference to FIGS. 1-6, numerical reference 1 will be assigned to a machine for the production of tiles having predetermined length L1, width L2 and thickness S, starting from a block 100 of marble, granite and the like.

The machine 1 comprises a base 10, two columns 2ʹ, 2ʺ mounted on said base 10, a bench 5 configured to support the block 100, and a first movable element 4, also called frame 4, arranged transversally with respect to said two columns 2ʹ, 2ʺ and arranged above the bench 5 and, during use, above said block 100, an insertion space for said block 100 being provided between said bench 5 and said first movable element 4.

The machine 1 may also comprise a trolley 50, arranged below the bench 5 to collect debris.

The base 10 is preferably made of concrete and may have a cavity 11 with two side recesses 12. Each side recess 12 is provided with a horizontal track 6, 6' running parallel to a first horizontal line X.

Bench 5, preferably made of steel, has a horizontal support surface 5' for positioning the block 100.

The bench 5 is also movably connected to said two tracks 6, 6' for its movement along the first horizontal line X, said bench 5 being movable on said tracks 6, 6' on both lines X1, X2.

Thus, advantageously, the block 100 may move along said first horizontal line X during use, as illustrated below.

The first movable element 4, preferably made of steel, is configured to move vertically along a vertical line Z. In the particular embodiment described herein, said first movable element is coupled to the columns 2ʹ, 2ʺ by means of movement means, such as for example, worm screws 20ʹ, 20ʺ mounted in the columns 2ʹ, 2ʺ, female screws and a gearmotor connected to a single shaft 21, for example arranged above said bridge.

It should be noted that in alternative embodiments, the machine may comprise several frames 4 connected to the same columns 2ʹ 2ʺ or connected to different columns so that their movement along the vertical line Z is independent of each other.

Referring to FIG. 6, the first movable element 4 comprises two portions 4ʹ, 4ʺ, wherein a first portion 4ʹ has a substantially rectangular-shaped horizontal section comprising a closed central opening, also substantially rectangular-shaped, and a second portion 4ʺ has a substantially “H”-shaped horizontal section comprising two side housings 40.

Therefore, said first portion 4ʹ of said first movable element 4 has two longitudinal sides 401, 402 which are parallel to said first horizontal line X, and a first transverse side 403 and a second transverse side 404 which are parallel to a second horizontal line Y, which is orthogonal to said first horizontal line X.

In particular, the first cutting direction X1 is defined as the direction along said first horizontal line X, from said first transverse side 403 to said second transverse side 404, while the return direction X2 is defined as the direction along said first horizontal line X, from said second transverse side 404 to said first transverse side 402.

Each of said sides 401, 402, 403, 404 has two faces, an inner face facing the inside of said hollow rectangular shape, and an outer face facing the outside.

Subsequently, two axes y′ which are integral with said first portion 4' of said first movable element 4, parallel to the second horizontal line Y and coplanar respectively to the inner and outer faces of said first transverse side 403, will be called first horizontal axes y′. The axis y″ integral with said first portion 4' of said first movable element 4, parallel to said second horizontal line Y and coplanar to said inner face of said second transverse side 404, will also be called with the term second horizontal axis y″.

In alternative embodiments, the first horizontal axes y′ and y″ may move independently along the vertical line Z, for example by being connected to different frames.

Finally, it is noted that the first portion 4' of the first movable element 4 is joined to the second portion 4" at the outer face of the second transverse side 404, for example by welding, such that the side housings 40 of the second portion 4" are aligned along said second horizontal line Y.

The machine 1 further comprises a predefined number of first mandrels M1, M2, ..., Mm, ..., Mn, each first mandrel M1, ..., Mn being positionable along at least a first horizontal axis y′, i.e. being positionable on at least one face of said first transverse side 403 of the first movable element 4, and lockable in position thereon.

In particular, an operator may position a subset of the first mandrels M1, M2, ..., Mm along at least one face of the first transverse side 403, depending on the width of the tiles to be obtained.

Furthermore, in a preferred embodiment of the machine 1, the mandrels M1, ..., Mn may be arranged in a staggered manner on both faces of said first transverse side 403 for reasons explained below.

The first mandrels M1, ..., Mn are also adjustable in height, for example they can be raised manually.

A first cutting means D1, ..., Dn, which in the case shown in the figures is a first rotating cutting disc D1, ..., Dn, can be coupled to each first mandrel M1, ..., Mn. Each disc D1, ..., Dn has one of said first horizontal axes y′ as its axis of rotation so as to be able to carv the block 100 parallel to said first horizontal line X.

In particular, said first discs D1, ..., Dn all have the same diameter and are arranged at the same height so as to be able to carv the block 100 at a predetermined depth S, depending only on the distance H-S of said first discs D1, ..., Dn from said support surface 5' and on the height H of said block 100 with reference to said vertical line Z.

Advantageously, when a disc D1, ..., Dn becomes worn, the corresponding mandrel M1, ..., Mn may be opportunely adjusted in height to compensate for such wear.

In an alternative embodiment, as shown in FIG. 7, a grinding wheel Dm’ may be coupled to a respective mandrel Mm instead of at least one flat cutting disc Dm. In particular, the presence of a shaped grinding wheel Dm’ may be particularly advantageous as it allows tiles to be obtained with a rounded side and an orthogonal side, “rounding” being typically a process that cannot be carried out on a thin tile as the stresses to which such tile would be subjected could lead to its breakage. Rounding is a typically desired process when making floor skirting, which must have a linear and a rounded side. Alternating a disc with a grinding wheel advantageously achieves such effect, which until now required particularly complex and expensive processing, making production uneconomic.

The machine 1 further comprises horizontal tracks coupled to the second transverse side 404 of the first portion 4' of the first movable element 4, at its inner face, said horizontal tracks running along said second horizontal axis y″.

However, in alternative embodiments, the horizontal tracks may be coupled to a different transverse side of the first movable element 4, or of another frame, when present, they being, for example arranged upstream of said discs D1, ..., Dn with reference to said first cutting direction X1. In any case, said tracks are configured in such a way that they can vary their position with respect to the vertical line Z and can move along said first horizontal line X with relative motion with respect to said support surface 5'.

Furthermore, the machine 1 comprises a second mandrel T, coupled to said horizontal tracks, wherein said second mandrel T is configured to take on at least two distinct positions along the vertical line Z, respectively a working position and a resting position.

A second cutting means E, which in the case described is a second disc E, can be coupled to said second mandrel T, said second disc E having said first horizontal line X as its axis of rotation so as to cut the block 100 along said second horizontal axis y″.

In particular, when said machine 1 is in use, if said second mandrel T is in working position, said second disc E may be arranged at the same height as said first discs D1, ..., Dn with reference to said support surface 5' so as to carv the block 100 at the same depth S as said first discs D1, ..., Dn.

On the contrary, said second disc E cannot cut the block 100 if said second mandrel T is in the resting position.

Said machine 1 may further comprise two motors (not shown in the figure) coupled to said second mandrel T, said two motors being a first motor for driving said second disc E and a second motor for managing the movement of the mandrel along said second horizontal axis y″, for example a motor controlled by a logic control unit, such as a PLC, the function of which will be better illustrated below.

Finally, said machine 1 comprises:
a horizontal blade 43, in particular a band saw 43, arranged at the outer face of said second transverse side 404;
two pulleys 41, 42, coupled to the outer face of said second transverse side 404 and to said horizontal blade 43, for tensioning the same; and
a third drive motor 8 for the movement of said horizontal blade 43.

Said horizontal blade 43 can be coupled to the pulleys 41, 42 and comprises a first cutting side 430 and a second smooth side 431.

The first cutting side 430 may comprise diamond elements and is configured to cut the entire block 100 at a predetermined height, with reference to said vertical line Z.

The cutting side 430 is the side of the horizontal blade 43 which cuts the block 100 and which guides the feed of the horizontal blade 43 itself, while the second smooth side 431 (shown for example in FIGS. 2 or 9) serves only to allow sufficient tensioning of the cutting side 430.

In particular, the diamond teeth may be sized to have very small thicknesses, but still be larger than the first cutting side 430. By way of example, the first cutting side 430 may have a thickness of about 1 mm, which increases to about 2 mm in the portions comprising the diamond teeth.

The horizontal blade 43 is therefore configured to cut the block 100 into two sub-blocks, a first sub-block having said thickness S as its thickness, and a second sub-block having, as its thickness, the initial thickness of the block 100 minus said thickness S, with reference to said vertical line Z. Said first cutting side 430 is therefore arranged at the same distance from said support surface 5' as said first discs D1, ..., Dn, with reference to the vertical line Z.

The horizontal blade 43 may further have all the known features of band saws, such as guide shoes, which may be hydrodynamic or friction shoes.

Said two pulleys 41, 42 may be a first driving pulley 41 and a second driven or idle pulley 42.

The pulleys 41, 42 are respectively inserted in the lateral housings 40 of the second portion 4ʺ of the first movable element 4 so that their position is stable during the use of the machine 1. Specifically, said first pulley 41 may be coupled to a first transverse side 401 of said first movable element 4 by means of a fork 410 and a pair of hydraulic cylinders, and may be connected to said drive motor 8 for its movement.

Said second pulley may be fixed to the second transverse side 402 of said frame 4 by means of swinging supports.

When said third drive motor 8 is actuated, the movement of the first pulley 41 sets the horizontal blade 43 in motion.

With particular reference to FIG. 8, the machine 1 may further comprise a movable bar 6, which is adjustable along the line Z and is coupled to the first transverse edge 402 of the first movable element 4, at its outer face. Such movable bar 6 comprises a plurality of spacer elements 7 having the shape of thin blades, also called “knives” 7. In particular, each spacer element 7 is aligned with a respective first disc D1, ..., Dn and is integral with the first movable element 4 in such a way that each spacer element 7 can pass in the cuts made by said first discs D1, ..., Dn, laterally blocking the formed tiles, at least as long as they are resting on said horizontal blade 43.

The spacer elements 7 may have a predetermined tolerance with respect to the width of the cut made by the respective first disc D1, ..., Dn. For example, each spacer element 7 in 4 mm cuts may be 3 mm thick.

This prevents the tiles from falling to the side. When the tile detaches by means of the horizontal blade 43, the same tiles remain resting on said horizontal blade 43, and not having any support element, could fall from the machine 1. Therefore, the spacer elements 7 may advantageously laterally contain such formed tiles. However, once the blade 43 has completely detached from the tiles, the spacer elements 7 no longer serve to support the formed tiles and may disengage from them.

In particular, during use, the movable bar 6 is arranged at a predetermined distance along the vertical line Z so that the knives can “travel” in the cuts made by said first discs D1, ..., Dn without the need to further move said movable bar 6 vertically.

Finally, said machine 1 may comprise an unloading paddle 44 coupled to the first transverse edge 402 of the first movable element 4 at its outer face, or to said movable bar, as shown in FIGS. 1-6. Such an unloading paddle 44 also has a working position and a resting position, for example being moved along the vertical line Z by means of two pneumatic or synchronous cylinders.

However, said unloading paddle 44 may not be present, as shown in the variant of the machine 1 shown in FIG. 9.

The trolley 50 for collecting debris is positioned in the cavity 11 below said bench 5 and the two side recesses 12, and is mounted on two respective inclined tracks running parallel to said first horizontal line X. In particular, said inclined tracks are inclined with respect to said vertical line Z so that the trolley 50 can pass from the inside of the cavity 11 towards the outside in order to be unloaded, for example by being emptied manually.

In alternative embodiments, the trolley 50 may be replaced by a conveyor belt that moves along said first horizontal line X, in particular being inclined with respect to said vertical line Z and carrying the debris where the client wishes. Advantageously, said belt can be activated automatically when the debris is unloaded.

FIGS. 10 and 11 show a further variant of the machine in FIG. 1, which differs from the first form shown in FIGS. 1-6, in that said first movable element 4 comprises only the first portion 4' of substantially rectangular section and the pulleys 41, 42 are positioned at the outer face of said second transverse side 404, for example being supported by it, in a so-called “cantilever” configuration.

Also in said embodiment, said first pulley 41 may be coupled to a first transverse side 401 of said first movable element 4 by means of a fork 410 and a pair of hydraulic cylinders or a single central cylinder, and may be connected to said drive motor 8 for its movement.

Said second pulley may be fixed to the second transverse side 402 of said frame 4 by means of swinging supports.

The solution proposed in FIGS. 10 and 11 is particularly advantageous for changing the horizontal blade 43, which is directly accessible, and for the construction of the machine. However, said embodiment could encourage the bending of the first movable element 4 and/or the generation of unacceptable vibrations on it. The cutting of a block 100 having height H by machine 1 to obtain tiles having dimensions L1 x L2 x S is carried out as follows.

In a first step, the block 100 is positioned on the support surface 5' so that its height H is along said vertical line Z.

In a second step, the first mandrels M1, ..., Mn are positioned along at least a first horizontal axis y′, at a distance L2 from each other, and said first mandrels M1, ..., Mn are blocked, said first mandrels M1, ..., Mn being coupled to respective first discs D1, ..., Dn. Thus, the first discs D1, ..., Dn are adapted to the production of tiles having width L2. During such step, the second mandrel T is placed in the resting position, outside the contour of the block 100. In addition, paddle 44, if present, is also placed in the resting position.

In a third step, the bench 5 is positioned so that the block 100 is arranged outside the first movable element 4, an edge of said block 100 being arranged at the first transverse side 403 of the first movable element 4.

In a fourth step, the first movable element 4 is positioned so that the discs D1, ..., Dn, E and the first cutting side 430 of the horizontal blade 43 are at a first vertical distance Z1 from said support surface 5', with reference to the vertical line Z, said first vertical distance Z1 being equal to

$$Z 1 = H \text{-} S .$$

In a fifth step, the first discs D1, ..., Dn are actuated and the bench 5 is moved along said first cutting direction X1 so as to move the block 100 positioned on it by a first length I1, with respect to the first movable element 4, said first length I1 being approximately equal to the maximum distance between the edge of the block 100 and the second mandrel T. Thus, during said step, said first discs D1, ..., Dn carv a series of longitudinal cuts having width L2, having depth S, on the block 100.

Simultaneously with said fifth step, the horizontal blade 43 is actuated by means of said pulleys 41, 42 and said drive motor so as to cut the cut portion of the block 100 along a horizontal plane, placed at height Z1, with reference to said support surface 5' of the bench 5.

In a sixth step, once the bench 5 has travelled said first length I1, the bench 5 stops and the second mandrel T passes into working position so that the second disc E cuts said block 100 parallel to said second horizontal line Y to obtain a first smooth edge of the tiles to be produced and a plurality of rejects having depth S. In such step, in the case of blocks 100 having a particularly irregular shape, the second disc E may also pass in a void, and therefore also some tiles formed in the subsequent iteration (illustrated below) may be considered rejects since they have a different shape than the desired one and irregular edges.

Subsequently, in a seventh step, the mandrel T returns to its resting position outside the contour of the block 100.

Said fifth, sixth and seventh steps are repeated with the following variation until said block 100 has travelled along its entire initial length: in particular, in the subsequent iterations, the length travelled by the block 5 along the first cutting direction X1 during said fifth step is equal to the length L1 of the tiles to be obtained.

In this way, a plurality of detached tiles having dimensions L1 x L2 x S are produced.

Furthermore, when the machine 1 comprises said movable bar 6 coupled to the spacer elements 7 or knives 7, said knives 7 pass, during said fifth or sixth step, in the carvings of said first discs D1, ..., Dn, and the formed tiles are advantageously blocked in position on the remaining portion of said block 100, even when they are partially resting on the horizontal blade 43.

When the block 100 has completely travelled the first movable element 4, the drive motors of the machine 1 stop and the first set of tiles is unloaded to an unloading area (not shown in the figures).

Such unloading of the tiles may advantageously be done automatically by means of a gantry robot or an anthropomorphic robot with suction cups.

A robot may unload the tiles obtained by means of the machine 1 without incurring tile breakage as the tiles have a reduced weight and size compared to semi-finished slabs produced by machines of the background art, for example compared to a slab split by means of a splitting machine.

During said unloading operation, the cut edges of the rejected block 100 may be left in place.

In a final step, the unloading paddle 44 may be lowered into the working position. Thus, by sliding the bench 5 in said return direction X2 to return it to its initial position, with the edge of the block 100 at the first transverse side 403, the unloading paddle 44 may touch the upper portion of the block 100 and allow the unloading of the processing rejects into the unloading trolley 50.

The rejects collected in the unloading trolley 50 may subsequently be extracted by moving the unloading trolley 50 on the respective inclined tracks so that it exits the cavity 11.

The procedure is then repeated to obtain further series of tiles until block 100 is exhausted, each time positioning, during said fourth step, the horizontal blade 43 and the discs D1, ..., Dn, E at a height of

$$Z \text{1} \text{=} H - n \times S ;$$

wherein Z1 is the height calculated by taking as reference the support surface 5' of said bench 5, and where n is the number of the series of tiles to be obtained on said block.

Finally, an initial upper grinding step of the block 100 may also be envisaged prior to the above-mentioned steps, wherein the block 100 is cut at the top only by means of the horizontal blade 43, with the first discs D1, ..., Dn raised with respect to the vertical line Z in such a way as not to cut the block 100 and eliminate the whole upper portion of the block 100 having an irregular and/or rough surface.

The machine 1 as described above has the following advantages over known machines:
the possibility of making thin tiles, with thicknesses between 1 mm or 2 mm and 10 mm, as no moving step for thin slabs is provided and as it makes the cut that defines the thickness as the last process, not stressing the tile with increased stresses at right angles to the surface; and
the possibility of carrying out complex processing, as the machine 1 makes cuts that represent the perimeter of the tiles before they are detached from the block; this is particularly advantageous as it gives the material being processed greater stability and strength, essentially equal to the stability and strength of the intact block 100.

The longitudinal and transversal cutting of the block 100 prior to the detachment of the tile by means of the horizontal blade 43 makes it possible to obtain tiles with quite reduced thickness compared to the background art (i.e. only a few millimetres). Such advantage was not attainable in any way by the machines of known art, as dividing the block 100 first into slabs and then subdividing the slabs into tiles led to the slabs breaking when they were only a few millimetres thick.

On the other hand, it was not possible to make longitudinal and transversal cuts on a block 100 with a first machine and the subsequent horizontal cut of said block 100 with a second machine arranged downstream of the first one by means of the machines of known art as such processing would have required very long times, for example having to continuously move the semi-finished block 100 (which usually has an initial weight of between 30 and 40 tons) from one machine to another and having to align the semi-finished block in each step.

Therefore, only the special design of the machine 1 according to this description enables tile processing otherwise considered impossible.

Furthermore, advantageously, the possibility of placing the first mandrels M1, ..., Mn in a staggered manner along both faces of the first transverse side 403 makes it possible to obtain tiles having a width L2 smaller than the contour of the mandrels M1, ..., Mn and/or of the discs D1, ..., Dn themselves, thus making it possible to obtain tiles having smaller dimensions than those obtainable with the known machines, for example mosaic tiles.

Furthermore, when said horizontal blade 43 cuts the tiles, it can advantageously erase any carving marks left by the discs D1, ..., Dn, E. Since the horizontal blade 43 is advantageously coupled to the outer face of the second transverse side 404, it cuts the block 100 only after it has been carved by the first discs D1, ..., Dn and possibly by the second disc E.

Furthermore, in order to optimise the production of tiles from a non-uniform block 100, the first length travelled by said first discs D1, ..., Dn during the first iteration may vary so as to even out the block, in case it has a jagged edge.

In addition, the dimensions of the tiles L1, L2 to be obtained can be programmed to vary during the processing of the block 100 so as to minimise processing rejects in the case of blocks 100 with non-uniform dimensions. The machine 1 will therefore be able to change, also automatically, the point of the first cut made by the second disc E by special sensors assessing the profile of the block 100 so as to maintain a tile production with constant width L2.

Alternatively, the machine 1 will be able to modify the width L2 of the tiles produced between layers in order to minimise the rejects, for example by varying said width between three or four sizes pre-set by an operator.

Additionally, detecting the perimeter of the block for the production of a further set of tiles may also be carried out by using external systems after the previous set of tiles has been cut. For example, top-down cameras and a logic control unit with specific software for detecting the profile of the block 100 may be used.

In general, the machine 1 may comprise a logic control unit for controlling the arrangement of said first mandrels M1, ..., Mn in such a way that the first mandrels M1, ..., Mn may switch from a resting position to a working position during the transition between the production of one set of tiles and the next set of tiles so as to vary the width L2 of the tiles during the cutting thereof, for example by means of a special program.

Furthermore, as seen, the distance L1 to be travelled before cutting by the second disc E may also be advantageously programmed to vary during the processing of the block 100.

A further advantage of the machine 1 is that the side recesses 12 of the cavity 11 of the base 10 are not transversely joined to each other, thus allowing ample space for the debris falling towards the collection trolley 50 once it has been pushed by the paddle 44.

However, the tiles obtained by machine 1 shown in FIGS. 1-6 or 10-11 or 14 might not always achieve the required quality levels for the following reason.

In the method illustrated above, the sliding of the bench 5 along said first cutting direction X1 must be stopped during said sixth step, but keeping the horizontal blade 43 in motion.

It is not possible to stop and restart the horizontal blade 43 once it is in the block 100 without risking the breakage of the cutting inserts or the blade itself.

Therefore, the horizontal blade 43 continues to act on the surface of the block 100 during said sixth step, which may create grooves/chips on the block 100 with consequent possible production of tiles with irregular surfaces, such defects being for example, manifested in a subsequent polishing step of the tiles obtained.

Such problem has been solved by making a machine 1 according to this invention, shown in FIGS. 12-13.

Said machine 1 comprises all the technical features of the machines 1 shown in FIGS. 1-6, and may also comprise optional features thereof, differing from it in that said second transverse side 404 is inclined by a first angle α<90°, with respect to said second horizontal line Y, and consequently, the second horizontal axis y″ and the tracks on which said second mandrel T slides are inclined by said first angle α with respect to said second horizontal line Y. In this way, also the axis of rotation of said second blade E is advantageously inclined by said angle α with respect to said first horizontal line X.

In particular, in said embodiment, said second disc E is configured to travel along said tracks during said sixth step, only along a second cutting direction Y1, with reference to said horizontal line Y. Said second cutting direction Y1 must be the direction from the point of said second transverse side 404 closest to the initial position of said block 100, with reference to said first horizontal line X, to the point of said second transverse side 404 farthest from the same initial position of said block 100.

In this embodiment, the speed of movement of said second disc E on the respective tracks is directed along the axis y″ and has a second intensity Ve which is directly proportional to the first intensity Vb of the speed of movement of the bench 5, it being equal to:

$$V e \text{=} V b \text{/} s e n \left(α\right) .$$

In this way, during said sixth step, the relative motion between the mandrel T and the bench 5 will be null with respect to said first horizontal line X, and said sixth step of cutting the block 100 by means of the second disc E may be advantageously carried out without blocking the movement of the bench 5 along said first cutting direction X1.

Said embodiment of the machine 1 is therefore particularly advantageous.

A further advantage of said embodiment is that the inclination of the second horizontal axis y″ means that the horizontal blade 43 never has to face the transverse cut previously made by the second cutting disc E along the entire width of the block 100 at the same time. This is particularly advantageous as this condition would lead to the horizontal blade having the cutting portion without lateral support on the upper side along its entire length engaged in cutting the block for a few seconds before “plunging” back to cut other material, the “guiding” action typically performed by the material arranged laterally to the diamond sector on both sides thus missing for a few seconds. On the contrary, by positioning the second horizontal axis y″ so that it is inclined by said angle α, even a small one, there will be a “smooth” passage of the blade on the transverse cut and 90%-95% of the length of the blade will remain guided in the cut it has made. This ensures that the horizontal blade 43 does not skid along the vertical line Z and that it remains well-guided, so that a straight and planar horizontal cut is possible even close to transverse cuts.

For this reason, preferably the first intensity Vb of the speed of movement of the bench 5 is caused to vary from an initial value Vb1, also called input speed, to a final value Vb2, also called working speed Vb2, which is greater than said initial value Vb1.

In particular, said initial value Vb1 is preferably equal to about 10% of the final value Vb2 in order to ensure the correct entry of the horizontal blade 43 into the block and to be able to increase the speed of movement Vb up to the value Vb2 only after this entry when the horizontal blade 43 is well-guided in the block 100.

A further advantage of said embodiment is that it increases production capacity compared to the machine 1 described in the previous embodiment.

In alternative embodiments (not shown), the second transverse side 404 may be inclined by an angle α′ with respect to said second horizontal line Y, which is different from the first angle of inclination α between second blade E (and thus, between second horizontal axis y″) and second horizontal line Y.

Advantageously, it is possible to modify the relative angle between the second horizontal axis y″ and the second blade E to obtain tiles with slanted edges.

In addition, the described ratio between intensity Ve and Vb can be multiplied to obtain tiles with slanted sides.

Finally, with particular reference to FIG. 14, a top view of a further possible variant of the machine 1 is shown.

Said machine 1 has all the features of the machine of FIGS. 1-6, except that it comprises pre-treatment means 9 for pre-treating the block 100, said pre-treatment means being able to be coupled to said outer face of the first transverse side 403.

Said outer face of said first transverse side 403 may provide tracks running parallel to said second horizontal line Y, said pre-treatment means 9 being coupled to said tracks, being able to slide on said tracks in both directions of motion by means of a fourth motor.

In particular, said pre-treatment means 9 may be an oxy-acetylene flame for sculpting the surface of the block before it is carved by said first discs D1, ..., Dn.

Such burning treatment must always be carried out on the whole block and not on the thin tiles formed as the thermal stresses caused by the oxy-hydrogen flame would cause them to break.

The aim of said treatment is to remove small portions of material by burning them off and to roughen the remaining surface for aesthetic or functional purposes, such as creating non-slip tiles.

Said pre-treatment means may also be a polishing head for polishing the surface of the block 100. In this way, the machine 1 can advantageously produce fully finished tiles, which do not require a final polishing treatment once they have been unloaded from the machine 1.

In alternative embodiments, said pre-treatment means may be mounted on a machine of the type shown in FIGS. 12 or 13.

Furthermore, said pre-treatment means may be mounted on inclined tracks in a manner similar to that described for the track of said second mandrel T, or a plurality of pre-treatment means mounted on a predetermined number of static heads may be provided.

Preferred embodiments and suggested variants of this invention have been described herein, but it is to be understood that experts in the field may make modifications and changes without departing from the scope of protection as defined by the appended claims.

1-15. (canceled)

16. A machine for producing tiles from a block, in particular a block of marble, granite and the like, said machine comprising:
a support surface for supporting said block;
a plurality of first cutting means for cutting said block parallel to a first horizontal line, said first cutting means being arranged above said support surface, comprising respective lower edges, configured for cutting said block longitudinally on the upper part, said lower edges being arranged at the same adjustable height, with reference to a vertical line, and being arranged with an axis aligned along at least a first horizontal axis, parallel to a second horizontal line, orthogonal to said first horizontal line;
a second cutting means for cutting said block transversally, i.e. parallel to said second horizontal line, said second cutting means being configured to move along a second horizontal axis relative to said support surface, said second horizontal axis being parallel or inclined by a first angle α<90°, with respect to said second horizontal line, said second cutting means comprising a resting position, wherein it does not interact with the block, and a working position, wherein it comprises a lower edge arranged at said same adjustable height as said first cutting means; and
a horizontal blade for cutting said longitudinally and transversally cut block along a horizontal plane, said horizontal blade comprising a first cutting edge arranged at said same adjustable height as said first cutting means,
wherein said support surface is apt to move on said horizontal line along a first cutting direction, relative to said first cutting means, to said second cutting means, and to said horizontal blade, said horizontal blade being arranged downstream of said first horizontal axis and said second horizontal axis, with reference to said first cutting direction.

17. The machine according to claim 16, wherein:
said first cutting means are a plurality of first rotating cutting discs having an axis of rotation along said at least one first horizontal axis; and/or
said second cutting mean is a second rotating cutting disc having an axis of rotation orthogonal to said second horizontal axis; and/or
said horizontal blade is a band saw.

18. The machine according to claim 16, further comprising spacer elements configured to fit into and pass through the cuts made on said block by means of said first cutting means.

19. The machine according to claim 16, further comprising pre-treatment means adjustable along said vertical line and movable along said first horizontal line relatively to said support surface, for pre-treating said block, said pre-treatment means being arranged upstream of said first discs with reference to said first cutting direction, and being movable or fixed with respect to said second horizontal line, said pre-treatment means preferably being an oxy-acetylene flame and/or a polishing head.

20. The machine according to claim 16, further comprising a paddle configured to be adjustable along said vertical line and movable along said first horizontal line, relative to said support surface, said paddle having a resting position, wherein said paddle does not interact with said block, and a working position, wherein said paddle is in contact with a top surface of said block or of said support surface.

21. The machine according to claim 16, wherein said first cutting means are arranged in a staggered manner on two first horizontal axes parallel to each other.

22. The machine according to claim 16, wherein the arrangement of said first cutting means on said at least one first horizontal axis is adjustable.

23. The machine according to claim 22, further comprising a logic control unit for controlling, during use, the arrangement of said first cutting means on said at least a first horizontal axis.

24. A method for cutting a plurality of tiles from a block, in particular a block of marble, granite and the like, said method comprising the following steps:
A. moving said block along a first cutting direction on a first horizontal line; and simultaneously
B1. longitudinally carving a top surface of said block with a plurality of carvings parallel to said first horizontal line, said plurality of carvings being spaced apart from one another by a first distance and having a predetermined depth, with reference to a vertical line;
B2. if said block has travelled a predetermined length with respect to said first cutting direction, transversally carving said top surface of said block at said predetermined length and at said predetermined depth, parallel to a second horizontal line, orthogonal to the first horizontal line, for the whole width of said block, optionally blocking the movement of said block in said first cutting direction;
B3. cutting the longitudinally and transversally carved portion of said block, carved in said step B1 and/or in said step B2, on a horizontal plane at said predetermined depth; and
C. executing said steps B1-B3 until said entire top surface of said block has been cut, obtaining a plurality of tiles having a length equal to a predetermined length, a width equal to said at least a first distance, a thickness equal to said predetermined depth; and
D. unloading said plurality of formed tiles and repeating said steps A-C, preferably until said block is exhausted.

25. The method according to claim 24, wherein during said step B1 and/or said step B2, a sub-step is provided of passage of spacer elements in said etchings parallel to said first horizontal direction in order to stabilise the position of said tiles formed on said block.

26. The method according to claim 24, further comprising the following step:
E. pre-treating the surface of said block intended to be etched in said step B1 by means of pre-treatment means, preferably by means of an oxy-acetylene flame and/or a polishing head.

27. The method according to claim 24, further comprising the following step:
F. removing any debris from said block.

28. The method according to claim 24, wherein, during said steps A, B1, B2 and B3, said block is moved at a speed having a first intensity Vb, with respect to said first cutting direction, the movement of said block in said first cutting direction not being blocked during said step B2;
wherein, during said step B2, said parallel carvings in said second horizontal line are made by means of a second cutting means which is movable along a second horizontal axis in a second cutting direction, said second horizontal axis being inclined by a first angle α<90° with respect to said second horizontal line, said second cutting means moving along said inclined direction at a speed of movement having a second intensity Ve equal to said first intensity Vb divided by the sine of said first angle α, so as to have a null relative speed of movement between said second cutting means and said block along said first horizontal.

29. The method according to claim 28, wherein said first intensity Vb of the speed of movement of said block varies from a first value Vb1 to a second value Vb2 which is greater than Vb1, said first value Vb1 preferably being equal to about 10% of Vb2.

30. The method according to claim 28, wherein the method is implemented by means of a machine for producing tiles from a block, said machine comprising:
a support surface for supporting said block;
a plurality of first cutting means for cutting said block parallel to a first horizontal line, said first cutting means being arranged above said support surface, comprising respective lower edges, configured for cutting said block longitudinally on the upper part, said lower edges being arranged at the same adjustable height, with reference to a vertical line, and being arranged with an axis aligned along at least a first horizontal axis, parallel to a second horizontal line, orthogonal to said first horizontal line;
a second cutting means for cutting said block transversally, i.e. parallel to said second horizontal line, said second cutting means being configured to move along a second horizontal axis relative to said support surface, said second horizontal axis being parallel or inclined by a first angle α<90°, with respect to said second horizontal line, said second cutting means comprising a resting position, wherein it does not interact with the block, and a working position, wherein it comprises a lower edge arranged at said same adjustable height as said first cutting means; and
a horizontal blade for cutting said longitudinally and transversally cut block along a horizontal plane, said horizontal blade comprising a first cutting edge arranged at said same adjustable height as said first cutting means,
wherein said support surface is apt to move on said horizontal line along a first cutting direction, relative to said first cutting means, to said second cutting means, and to said horizontal blade, said horizontal blade being arranged downstream of said first horizontal axis and said second horizontal axis, with reference to said first cutting direction.

31. The machine according to claim 17, further comprising spacer elements configured to fit into and pass through the cuts made on said block by means of said first cutting means.

32. The machine according to claim 17, further comprising pre-treatment means adjustable along said vertical line and movable along said first horizontal line relatively to said support surface, for pre-treating said block, said pre-treatment means being arranged upstream of said first discs with reference to said first cutting direction, and being movable or fixed with respect to said second horizontal line, said pre-treatment means preferably being an oxy-acetylene flame and/or a polishing head.

33. The machine according to claim 18, further comprising pre-treatment means adjustable along said vertical line and movable along said first horizontal line relatively to said support surface, for pre-treating said block, said pre-treatment means being arranged upstream of said first discs with reference to said first cutting direction, and being movable or fixed with respect to said second horizontal line, said pre-treatment means preferably being an oxy-acetylene flame and/or a polishing head.

34. The machine according to claim 17, further comprising a paddle configured to be adjustable along said vertical line and movable along said first horizontal line, relative to said support surface, said paddle having a resting position, wherein said paddle does not interact with said block, and a working position, wherein said paddle is in contact with a top surface of said block or of said support surface.

35. The machine according to claim 18, further comprising a paddle configured to be adjustable along said vertical line and movable along said first horizontal line, relative to said support surface, said paddle having a resting position, wherein said paddle does not interact with said block, and a working position, wherein said paddle is in contact with a top surface of said block or of said support surface.
